(19) United States
(12) Patent Application Publication
(10) Pub. No.: US 2007/0112131 A1
(43) Pub. Date: May 17, 2007

(54) Thermoplastic elastomer using waste rubber and rubber product produced therefrom

(75) Inventor: Jin-Kuk Kim, Gyeongsangnam-do (KR)

Correspondence Address: JENKENS & GILCHRIST, P.C., 901 15TH STREET N.W., SUITE 900, WASHINGTON, DC, 20005, US

(73) Assignee: Industry-Academic Cooperation Foundation, Gyeongsangnam-do (KR)

(21) Appl. No.: 11/519,761

(22) Filed: Sep. 13, 2006

(30) Foreign Application Priority Data
Nov. 14, 2005 (KR) 10-2005-0108564

(51) Int. Cl. C08L 51/00

(52) U.S. Cl. 525/70

(57) ABSTRACT

Disclosed are a thermoplastic elastomer using waster rubber and a rubber product produced therefrom. This invention provides a thermoplastic elastomer using waste rubber, obtained by loading a mixture comprising waste rubber powder, an olefin-based thermoplastic resin, and a compatibilizer selected from styrene compounds into an extruder and then kneading it, and a rubber product produced therefrom. The extruder is preferably a twin-screw extruder in which two shafts, each having at least two forward screw parts, at least one kneading disc part, and at least one backward screw part, are arranged in parallel to each other. The thermoplastic elastomer according to this invention has rubber properties and thermoplastic properties and may be recycled several times.

### BACKGROUND OF THE INVENTION

1. Field of the Invention

The present invention relates to a thermoplastic elastomer using waste rubber and a rubber product produced therefrom, and more particularly, to a thermoplastic elastomer, which is capable of being recycled several times by subjecting waste rubber powder, an olefin-based thermoplastic resin and a compatibilizer to dynamic reaction using an extruder so as to convert the waste rubber into a thermoplastic rubber material, and to a rubber product produced therefrom.

2. Description of the Related Art

In modern industrial societies which produce great quantities of waste, waste rubber, such as waste tires, is regarded as one of the most serious environmental problems. The waste rubber has been treated to date through a burning process or a burying process. However, burning or burying treatment causes emission of various harmful materials such as dioxin, and offensive odors. Accordingly, attempts have been made to pulverize waste rubber such as waste tires to recycle them by ways of a mixture with a resin binder so as to be suitable for use in paving a road. As such, however, since the conventional recycling process is responsible for only a filling function, recycling efficiency is very low and it is impossible to conduct a recycling process several times.

Typically, rubber products, such as automobile tires, are produced by adding natural rubber with carbon black as a strength reinforcing agent and then vulcanizing it, and have thermosetting properties. Ultimately, when heat is applied to such a rubber product, the rubber product is carbonized and therefore cannot be recycled into other rubber products. That is, the first rubber product is not melted and is thus impossible to further mold into second and third rubber products.

Further, as a rubber material different from the thermosetting rubber material mentioned above, a thermoplastic vulcanizate (TPV) has been commercialized these days.

The TPV is receiving attention as a next-generation material to replace the thermosetting rubber material from the point of view of environmental protection. A representative example is Santoprene, available from AES, USA, which is a product manufactured by subjecting EPDM and PP to dynamic vulcanization.

The TPV has both rubber properties and thermoplastic properties, such that it may be melted by heat and also may be recycled into other rubber products. Also, since the TPV may be advantageously substituted for almost all of conventional rubber materials, much research effort is being directed toward this compound.

Moreover, TPV manufacturers, such as AES, Shell Chemical, Dupont, and JSR, having high market shares of TPVs, have adopted a batch process using an inner mixer. Although process conditions or material mixing tables are not published by respective manufacturers, a first batch type blending process and a second extrusion process that is a pelletization process to obtain a predetermined product may be applied. In Korea, Dongil Rubber Belt Company, LG Chemical, and Honam Petrochemical Corporation have prepared TPV using a batch type which is a preparation process adopted by foreign manufacturers.

Since the TPV is composed not of waste rubber but of virgin rubber as a main component for realizing rubber properties thereof, it may have rubber properties the same as conventional rubber. However, upon the preparation of TPV, in the case where waste rubber is used as the main rubber component instead of virgin rubber, it has very low reactivity with the thermoplastic resin and thus lacks properties required for conventional rubber products.

According to conventional techniques, a general thermosetting rubber material is carbonized by heat and cannot be recycled into other rubber products. Separately, the TPV may be recycled through a melting process because it has rubber properties and thermoplastic properties. However, when the main rubber component of the TPV is replaced into waste rubber, a technical means for reacting with the thermoplastic resin is not proposed, and the waste rubber lacks properties required for conventional rubber products and hence is unsuitable for use therein.

Further, in regard to the recycling of waste rubber, because such a conventional recycling process is responsible for only a filling function, a problem of low recycling efficiency may occur.

Also, according to conventional techniques related to the production process of rubber products such as wheels and automobile bumpers, a rubber product resulting from a general thermosetting rubber material is composed mainly of rubber containing carbon black to obtain necessary properties. Hence, a compression molding process essentially requiring a vulcanization process is applied, whereby the production process is complicated and the production period is lengthened.

In addition, for a rubber product produced using the TPV, since a first batch type blending process for synthesis of TPV and a second pelletization process for realization of a product are separately performed, the production process is complicated. Particularly, when the batch type, in which it is difficult to continuously feed the components, is adopted, there are disadvantages of a long production period and requirement for large facilities, as well as time loss.

Therefore, there is urgently required the development of waste rubber recycling techniques which cause minimal environmental impact and which develop new materials and energy required for a recycling process while conserving resources. Particularly, there are also required techniques for replacing conventional thermosetting rubber materials or TPV materials while realizing the effective recycling of waste rubber by converting the waste rubber into thermoplastic rubber materials capable of being recycled several times, instead of a conventional recycling process responsible for only a filling function.

### SUMMARY OF THE INVENTION

Accordingly, the present invention has been made keeping in mind the above problems occurring in the related art, and an object of the present invention is to provide a thermoplastic elastomer, which has high recyclability and may be prepared through a simple process, by subjecting a mixture comprising waste rubber powder and olefin-based thermoplastic resin, as main components, and a compatibilizer to dynamic reaction using an extruder so as to convert the waste rubber into a thermoplastic rubber material, and a rubber product produced therefrom.

In order to accomplish the above object, the present invention provides a thermoplastic elastomer using waste rubber, obtained by loading a mixture comprising waste rubber powder, an olefin-based thermoplastic resin, and a compatibilizer selected from styrene compounds into an extruder and then kneading it. As such, the extruder is preferably a twin-screw extruder in which two shafts, each having at least two forward screw parts, at least one kneading disc part, and at least one backward screw part, are arranged in parallel to each other.

In addition, according to the preferred embodiment of the present invention, the waste rubber powder may have an amine group introduced thereto.

Further, the present invention provides a rubber product, produced by pelletizing the thermoplastic elastomer and then loading pellets into a mold.

### BRIEF DESCRIPTION OF THE DRAWINGS

FIG. 1 is a cutaway perspective view of a single-screw extruder;

FIG. 2 is a cutaway perspective view of a twin-screw extruder used in the present invention;

FIG. 3 is a cross-sectional view of the twin-screw extruder used in the present invention;

FIG. 4 is a cross-sectional view of the main portion of the twin-screw extruder used in the present invention;

FIG. 5 is a photograph of a wheel produced in the example of the present invention;

FIG. 6 is a graph showing the results of measurement of mechanical properties in the example and comparative example;

FIG. 7 is a graph showing the average residence time depending on the rotation speed of the screws;

FIG. 8 is a graph showing the results of measurement of mechanical properties depending on the rotation speed of the screws;

FIG. 9 is a graph showing the results of measurement of mechanical properties depending on the amount of compatibilizer; and

FIG. 10 is a graph showing the results of measurement of mechanical properties depending on the mixing ratio of waste tire and PP.

### DESCRIPTION OF THE PREFERRED EMBODIMENTS

Hereinafter, a detailed description will be given of the present invention.

The thermoplastic elastomer of the present invention is prepared by kneading a mixture comprising waste rubber powder as a main component using an extruder and thus has rubber properties and thermoplastic properties. Specifically, the thermoplastic elastomer is an extrudate obtained by crosslinking a mixture comprising waste rubber powder, an olefin-based thermoplastic resin and a compatibilizer through dynamic reaction for a sufficient residence time in an extruder and then extruding it. As such, a twin-screw extruder having a suitable screw configuration is preferably used. Further, the thermoplastic elastomer of the present invention has a shape corresponding to the cross-section of the die of the extruder, and specifically includes a sheet shape, a band shape, a rod shape (a hollow tube shape), etc.

In addition, the rubber product according to the present invention is a product produced from the thermoplastic elastomer above. Specifically, the rubber product of the present invention is produced by pelletizing the thermoplastic elastomer, loading the pellets into a mold, and conducting injection molding or extrusion molding. For example, brake pedals, automobile bumpers, etc., may be produced, and preferably wheels of a garbage can are exemplary.

The waste rubber powder used in the preparation of the thermoplastic elastomer of the present invention results from the pulverization of industrial waste rubber, waste rubber products, such as urethane shoe soles, automobile tires, automobile urethane bumpers, etc., and preferably has 8 wt % or less of impurities.

As the waste rubber powder, useful is waste rubber which has been produced by adding a rubber material, such as ethylene propylene diene monomer (EPDM) rubber, styrene-butadiene rubber (SBR), nitrile rubber (NR), isobutylene-isoprene rubber (IIR), or nitrile-butadiene rubber, with carbon black and then vulcanizing it. Preferably, waste tire rubber powder obtained from automobile wheels and waste EPDM powder obtained from automobile weather stripping (weather stripping rubber powder) are used.

The waste rubber powder preferably has a particle size of 10˜300 μm. As such, if the waste rubber powder has a particle size less than 10 μm, rubber elasticity is decreased. On the other hand, if the particle size exceeds 300 μm, reactivity with the thermoplastic resin is undesirably decreased.

The waste rubber powder, which imparts rubber elastic properties to the thermoplastic elastomer of the present invention, physically reacts with the olefin-based thermoplastic resin in the extruder (preferably, the twin-screw extruder) and is thus converted into the thermoplastic elastomer. In this case, according to the present invention, the surface functional group of carbon black contained in the waste rubber powder is reactive to the olefin-based thermoplastic resin. Specifically, the hydroxyl group (—OH) of carbon black reacts with the functional group of the thermoplastic resin.

The thermoplastic resin includes olefins, and specific examples thereof include polypropylenes (PP), polyethylenes (PE), polyurethanes (PU), or copolymers thereof. Further, among polypropylenes (PP), isotactic PP, random coPP, are maleic anhydride grafted polypropylene (PP-g-MA) are preferable, and furthermore, PP-g-MA is more preferable. Specifically, in the PP-g-MA, the maleic acid group acts as a reactive group and thus reacts with —OH group of carbon black, consequently improving mechanical properties.

As the compatibilizer, any styrene compound having a styrene unit may be used so long as it reacts with each of the waste rubber powder and the olefin-based thermoplastic resin. For example, the compatibilizer is a styrene-based thermoplastic elastomer, including styrene-ethylene-butadiene-styrene (SEBS) or maleic anhydride grafted styrene-ethylene-butadiene-styrene (SEBS-MA).

The compatibilizer is an important component which should be added to achieve the purpose of the present invention since the main component of the thermoplastic elastomer is waste rubber powder. In the case where such a compatibilizer is not added, compatibility of the waste rubber powder and the olefin-based thermoplastic resin is drastically decreased, leading to mechanical properties unsuitable for recycling into rubber products. Specifically, the compatibilizer reacts with each of the waste rubber powder and the olefin-based thermoplastic resin to form a network structure, thus realizing high mechanical properties.

Such a mixture comprising the waste rubber powder, the olefin-based thermoplastic resin, and the compatibilizer is mutually reacted in a twin-screw extruder and thus is converted into a thermoplastic elastomer. As such, reaction mechanisms are represented below: 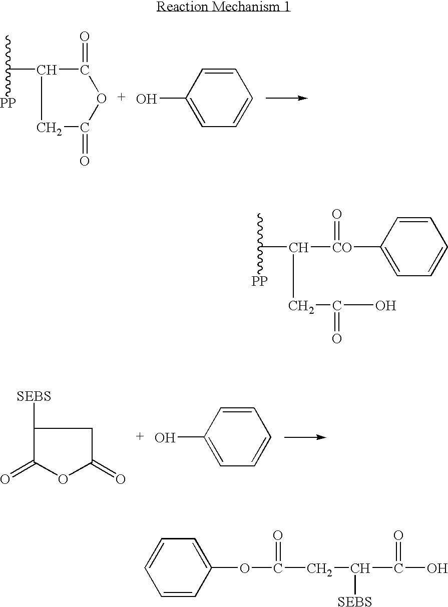
<Interaction between MA (Maleic Anhydride) and —OH of Carbon Black> 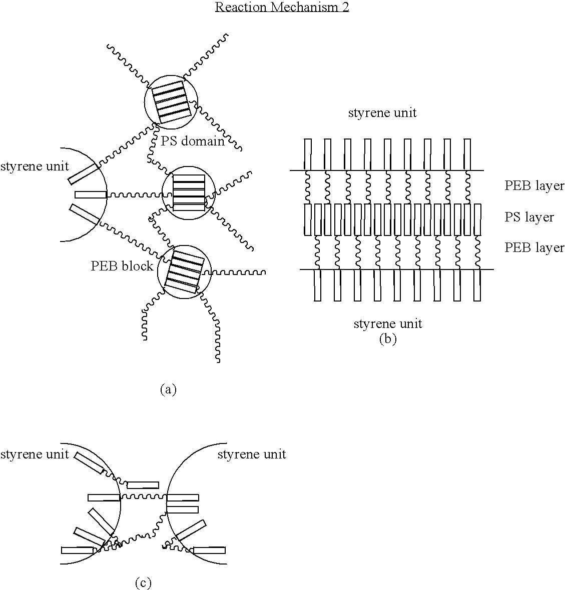
<Interaction between Styrene of SEBS-G-MA and Styrene in Waste Tire> 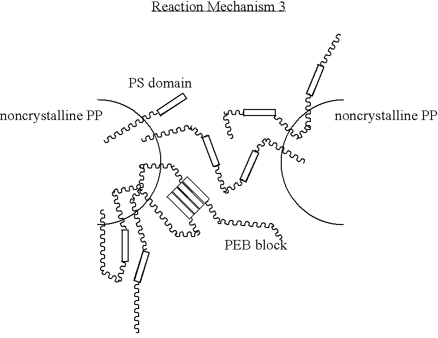
<Interaction between Noncrystalline Portion of PP-G-MA and EB Block of SEBS-G-MA>

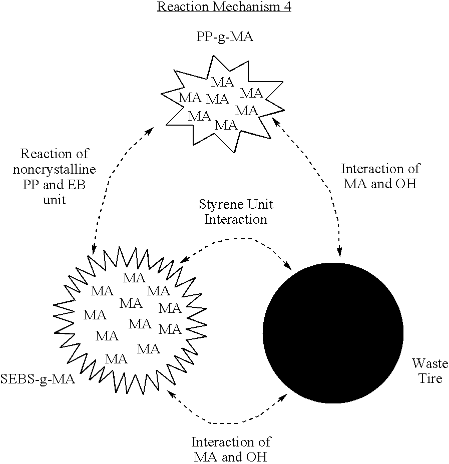

As represented in Reaction Mechanism 1, a maleic anhydride (MA) group, which is a reactive group of PP-g-MA, reacts with a hydroxyl group (—OH) on the surface of carbon black contained in waste tire. In addition, the MA group of SEBS-g-MA reacts with a hydroxyl group (—OH) on the surface of carbon black.

As represented in Reaction Mechanism 2, S (styrene) of SEBS-g-MA interacts with S (styrene) of SBR which constitutes waste tire.

Further, as represented in Reaction Mechanism 3, the PP of the noncrystalline portion of PP-g-MA interacts with the ethylene-buthylene (-EB-) group of SEBS-g-MA.

Thus, as represented in Reaction Mechanism 4, three components of the thermoplastic elastomer mutually interact with one another. In this case, a network structure is formed through the crosslinking of the compatibilizer (SEBS-g-MA), leading to high mechanical properties.

According to the preferable embodiment of the present invention, the waste rubber powder is irradiated with UV to introduce an amine group thereto before being loaded into the extruder. In this way, in the case where the amine group is introduced to the rubber component of waste rubber, the amine group is activated as a reactive functional group and therefore reactivity becomes good.

The UV irradiation is conducted in a manner such that the waste rubber powder is mixed with an amine compound-dissolved solution, dried and then irradiated with UV for about 20˜50 min. Specifically, 1.25 mol allylamine and 0.125 mol benzophenone are dissolved in 1 L of acetone. Then, waste tire powder is added to the above amine solution, stirred for about 3 hours, and then dried at room temperature for about 3 hours. The dried waste tire powder is irradiated with UV for 30 min. The reaction mechanism in which the waste tire powder has an amine group through such UV treatment is represented below:

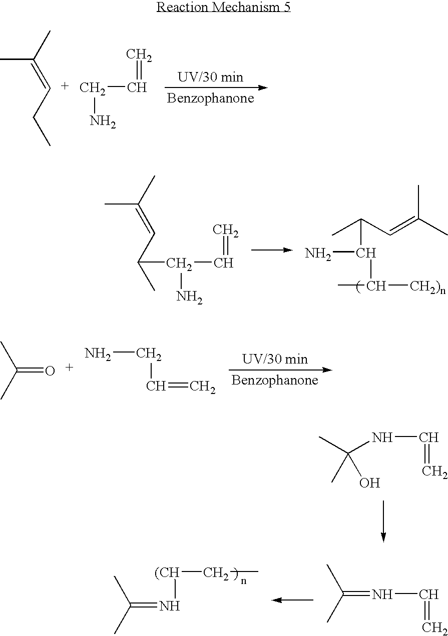

The thermoplastic elastomer of the present invention is obtained by subjecting the mixture comprising the waste rubber powder, the olefin-based thermoplastic resin and the styrene-based compatibilizer to dynamic reaction using an extruder. Although not being particularly limited, the mixture is composed of 65˜70 parts by weight of the waste rubber powder, 35˜25 parts by weight of the olefin-based thermoplastic resin, and 5˜10 parts by weight of the compatibilizer. That is, the weight ratio of waste rubber powder to olefin-based thermoplastic resin to compatibilizer is preferably 65-70:35˜25:5-10. As such, when the amount of waste rubber powder exceeds 70 parts by weight, mechanical properties are deteriorated due to too strong rubber properties. On the other hand, when the amount thereof is less than 65 parts by weight, the amount of thermoplastic resin is relatively increased, such that the material is difficult to soften and elastic restorability is drastically decreased. Further, if the amount of olefin-based thermoplastic resin is less than 25 parts by weight, mechanical properties are deteriorated and reactivity is decreased. On the other hand, if the above amount exceeds 35 parts by weight, rubber properties are undesirably decreased. Furthermore, when the compatibilizer is less than 5 parts by weight, mechanical properties are deteriorated due to low reactivity. On the other hand, when the above amount exceeds 10 parts by weight, the amounts of waste rubber powder and thermoplastic resin are relatively decreased, whereby elastic properties and mechanical properties, both of which are required in the present invention, are insufficiently manifested.

Also, according to the present invention, the mixture comprising the waste rubber powder, the olefin-based thermoplastic resin and the compatibilizer should be reacted through dispersion and mixing in the extruder having a suitable screw configuration so as to exhibit excellent mechanical properties capable of substituting for conventional rubber materials. Specifically, in the case where the mixture is placed into an extruder for merely extruding a loaded material, the waste rubber powder is not crosslinked with the olefin-based thermoplastic resin and the compatibilizer and thus the final extrudate in a die is a powder mixture in a slurry state, unsuitable for production of a rubber product. Accordingly, the loaded material is required to sufficiently react though kneading and dispersion using a suitable screw configuration. Specifically, an extruder having a forward screw, a backward screw and a kneading disc is used. In particular, a twin-screw extruder described below is preferable.

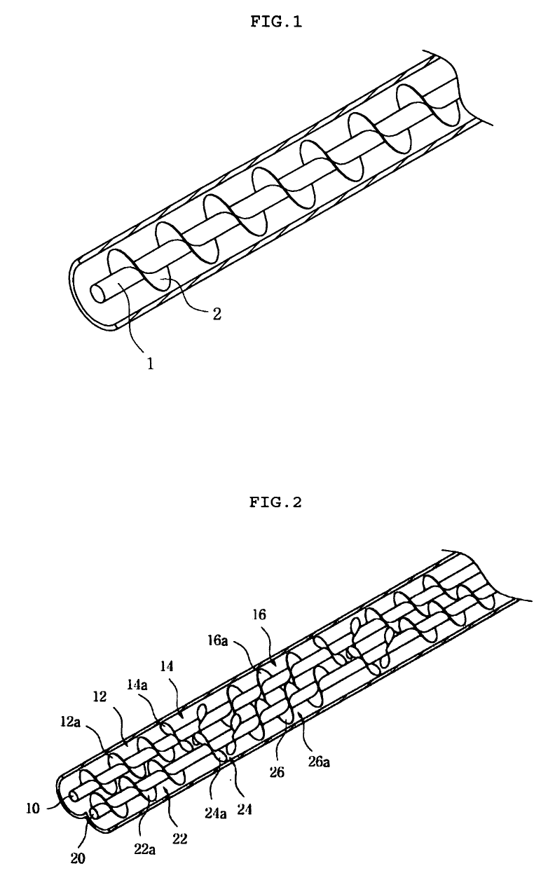

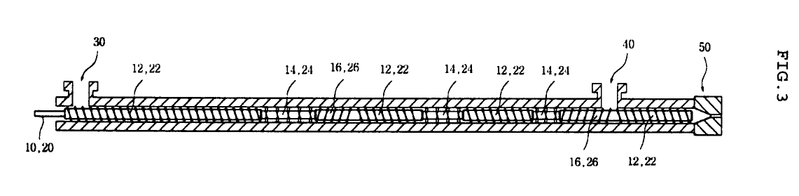

The twin-screw extruder has two shafts arranged in parallel to each other, and is described with reference to the appended drawings. FIG. 1 is a cutaway perspective view showing the single-screw extruder for merely pumping a loaded material and FIG. 2 is a cutaway perspective view schematically showing the twin-screw extruder effectively used in the present invention.

As shown in FIG. 1, since the single-screw extruder has a single shaft 1 to which only a forward screw 2 is attached, it may function not to disperse and mix the mixture for a sufficient residence time but to pump the mixture in one direction.

However, as shown in FIG. 2, the twin-screw extruder, preferably used in the present invention, has two shafts 10, 20 composed of a first shaft 10 and a second shaft 20, respective shafts 10, 20 including forward screw parts 12, 22, kneading disc parts 14, 24 and backward screw parts 16, 26. In this case, the forward screw parts 12, 22 function to pump the loaded mixture in a forward direction through rotation force of screws 12a, 22a attached thereto, and the kneading disc parts 14, 24 function to disperse and mix the mixture through rotation force of discs 14a, 24a attached thereto. Further, the backward screw parts 16, 26 function to change the flow of the mixture in a backward direction through rotation force of screws 16a, 26a attached thereto so that the mixture has a sufficient residence time. That is, the mixture passed through the kneading disc parts 14, 24 is transferred again toward the kneading disc parts 14, 24 in order to have sufficient dispersibility and mixability. As such, the discs 14a, 24a of the kneading disc parts 14, 24 are assembled to have an angle different from those of the other parts, thereby controlling dispersion and mixing effects.

FIG. 3 is a cross-sectional view showing the twin-screw extruder more effectively applied in the present invention. Referring to FIG. 3, the twin-screw extruder comprises a hopper 30 for feeding a mixture (raw material), a vent 40 for controlling the internal pressure of the extruder while emitting gas generated in the extruder, and a die 50 for discharging the extrudate, in which a first shaft 10 and a second shaft 30 are arranged in parallel to each other. As such, in the inner structure of the twin-screw extruder, respective first shaft 10 and second shaft 20 have two or more forward screw parts 12, 22, one or more kneading disc parts 14, 24, and one or more backward screw parts 16, 26. Specifically, the forward screw parts 12, 22 should be positioned at both ends of the shafts 10, 20, between which the kneading disc parts 14, 24 and the backward screw parts 16, 26 are respectively provided at one or more positions. In this case, when the number of kneading disc parts 14, 24 and backward screw parts 16, 26 is increased, dispersibility, kneadability and residence time are increased and thus the reactivity of the mixture becomes good. However, if the above parts are too numerous, productivity is undesirably decreased.

In FIG. 3, the twin-screw extruder having four forward screw parts 12, 22, three kneading disc parts 14, 24 and two backward screw parts 16, 26 is illustrated.

Specifically, FIG. 3 illustrates the twin-screw extruder comprising the hopper 30, the forward screw parts 12, 22, the kneading disc parts 14, 24, the backward screw parts 16, 26, the forward screw parts 12, 22, the kneading disc parts 14, 24, the forward screw parts 12, 22, the kneading disc parts 14, 24, the backward screw parts 16, 26, and the forward screw parts 12, 22, which are sequentially positioned. Such a twin-screw extruder is operated at 80˜150 rpm and at 190˜240° C.

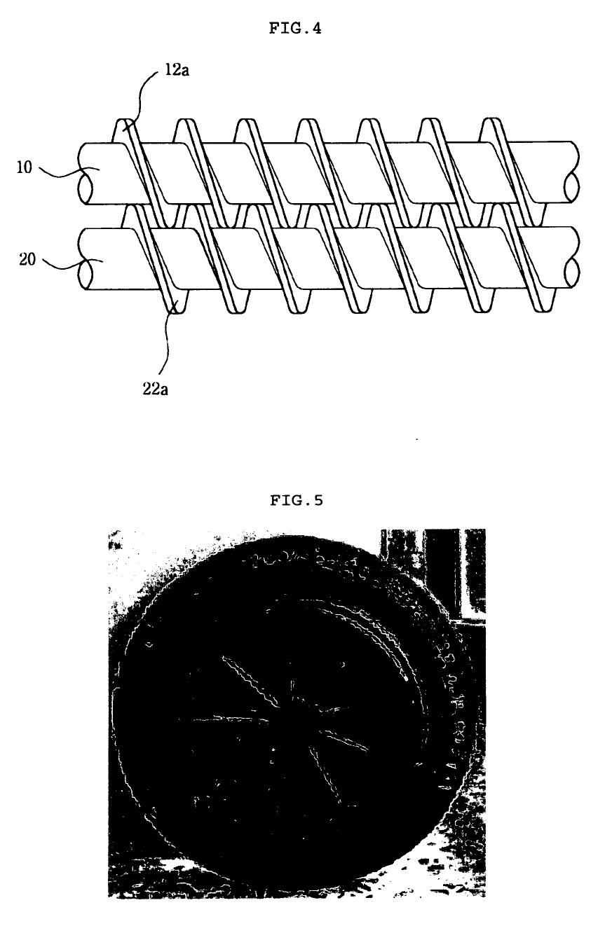

The twin-screw extruder is preferably provided in the form of intermeshing to improve dispersibility and mixability of the loaded mixture through rotation of forward screw parts 12, 22 engaged with each other and backward screw parts 16, 26 engaged with each other in the first shaft 10 and the second shaft 20. That is, as shown in FIG. 4, it is preferred that the first shaft 10 and the second shaft 20 be adjacently arranged in order to engage the screws 12a, 22a attached to respective shafts 10, 20 with each other.

The thermoplastic elastomer thus prepared is pelletized, injected at 225˜235° C. under pressure of 1000˜1500 psi and molded at 20˜30° C., thus producing various rubber products. FIG. 5 illustrates the rubber product according to the present invention, and specifically shows a photograph of a wheel produced in the example of the present invention.

Therefore, with the goal of achieving the recycling of waste rubber through conversion into thermoplastic rubber material, the present invention is characterized in that the compatibilizer, capable of reacting with each of the waste rubber powder and the olefin-based thermoplastic resin, is supplied to realize a network structure, and the extruder (preferably, the twin-screw extruder), functioning to knead the mixture for a sufficient period of time so as to allow the components to react while continuously pumping it, is used.

In addition, the thermoplastic elastomer according to the present invention, having rubber properties and thermoplastic properties able to melt the elastomer by heat, is molded into a rubber product. After the completion of use of such a product, it may be recycled several times through a melting process.

A better understanding of the present invention may be obtained in light of the following examples and comparative examples, which are set forth to illustrate, but are not to be construed to limit the present invention.

### EXAMPLE 1

For the preparation of a mixture, 65 parts by weight of waste tire powder having an average particle size of 50˜100 μm, 35 parts by weight of PP (PP-g-MA having Mw 15,000, SK Corporation, Korea, trade name: RE 340B) as an olefin-based thermoplastic resin and 5 parts by weight of SEBS-MA (Shell Chemical, trade name: Kraton 1901X) as a compatibilizer were mixed. The mixture was loaded into a twin-screw extruder (Bau Tech model BA-19, Korea) having a suitable screw configuration shown in FIG. 3 to subject it to dynamic reaction at a rotation speed of 100 rpm and at a barrel temperature of 200˜235° C. for residence time of 3˜4 min, thus extruding an olefin-based thermoplastic elastomer.

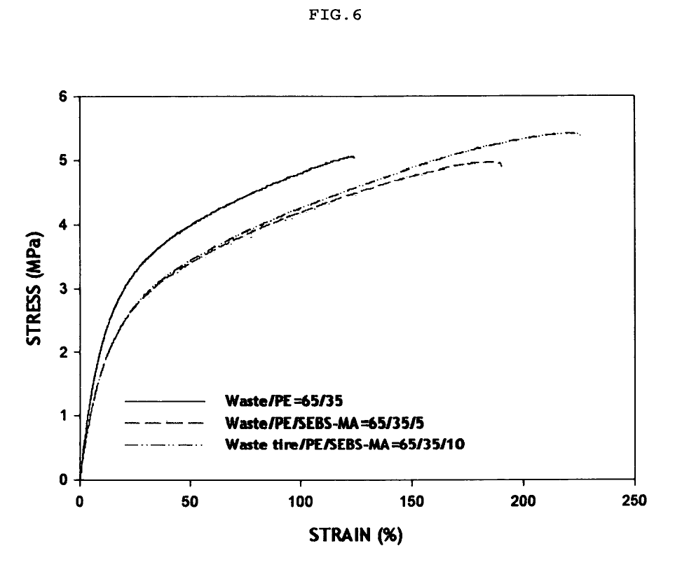

Thereafter, the thermoplastic elastomer was injected at 230° C. under pressure of 1250 psi and then molded at a mold temperature of 30° C., thus producing a sample. As such, the injection cycle time was set to 30 sec. The mechanical properties of the sample were measured. Using a universal test machine (UTM), tensile strength and elongation were measured at a tensile speed of 50 mm/min with 10 kN load cell. The results are shown in a graph of FIG. 6.

### EXAMPLE 2

A mixture was prepared in the same manner as in Example 1, with the exception that 65 parts by weight of waste tire powder having an average particle size of 50˜100 μm, 35 parts by weight of PP (PP-g-MA having Mw 15,000, SK Corporation, Korea, trade name: RE 340B) as an olefin-based thermoplastic resin and 10 parts by weight of SEBS-MA (Shell Chemical, trade name: Kraton 1901X) as a compatibilizer were mixed. That is, in the present example, the amount of compatibilizer was double that of Example 1. Subsequently, a sample was produced as in Example 1, and the tensile strength and elongation thereof were measured. The results are shown in FIG. 6.

### COMPARATIVE EXAMPLE 1

A mixture was prepared in the same manner as in Example 1, with the exception that 65 parts by weight of waste tire powder having an average particle size of 50-100 μm, and 35 parts by weight of PP (PP-g-MA having Mw 15,000, SK Corporation, Korea, trade name: RE 340B) as an olefin-based thermoplastic resin were mixed. That is, in the present comparative example, the compatibilizer was not added. Subsequently, a sample was produced as in Example 1, and the tensile strength and elongation thereof were measured. The results are shown in FIG. 6.

From FIG. 6 (graph), it can be seen that the results of tensile strength and elongation of Examples 1 and 2, in which the compatibilizer is added, are superior to those of Comparative Example 1 in which the compatibilizer is not added.

In addition, in order to evaluate the mechanical properties depending on the rotation speed of the screws of the twin-screw extruder, the amount of compatibilizer and the mixing ratio, the following tests were conducted.

The test was variously carried out using a plurality of twin-screw extruders having suitable screw configurations by adjusting the length of forward screw parts 12, 22 and backward screw parts 16, 26, the number of screws 12a, 16a, 22a, 26a, the length of kneading disc parts 14, 26, and the number of discs. In particular, the results of the twin-screw extruder (Bau Tech model BA-19, Korea) exhibiting good dispersibility are described below.

[Evaluation of Residence Time and Mechanical Properties over Rotation Speed of Screws]

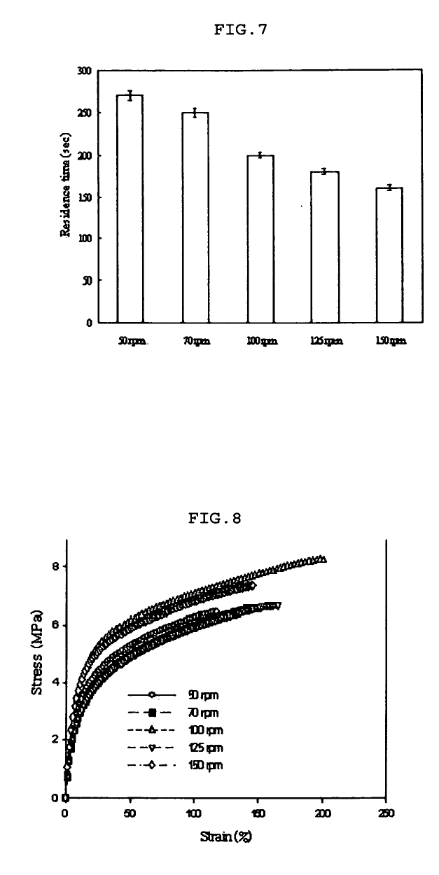

The mixture prepared in Example 2 was loaded into a twin-screw extruder, and the average residence time and mechanical properties were measured depending on the rotation speed of the screws. The composition of the mixture loaded into the twin-screw extruder was composed of waste tire powder:PP-g-MA:SEBS-MA=65:35:10 at a weight ratio. The results are shown in FIGS. 7 and 8, in which FIG. 7 is a graph showing the average residence time depending on the rotation speed of the screws, and FIG. 8 is a graph showing the mechanical properties depending on the rotation speed of the screws.

As shown in FIGS. 7 and 8, as the results of measurement depending on the rotation speed of the screws, it has been confirmed that the sufficient residence time may be ensured at a low rotation speed, but the distribution of waste rubber is poor due to a low sheer speed, thus deteriorating the properties. Further, at high rotation speeds of 125 rpm and 150 rpm, although the distribution of waste rubber is good thanks to a high sheer speed, the properties are undesirably deteriorated due to the short reaction time between the waste rubber and the PP resin. Consequently, excellent properties can be manifested at the rotation speed of 100 rpm suitable for the sufficient sheer speed and residence time. In addition, the mechanical properties varying with the amount of compatibilizer at the rotation speed of 100 rpm were evaluated as follows.

[Evaluation of Mechanical Properties Depending on Change in Compatibilizer]

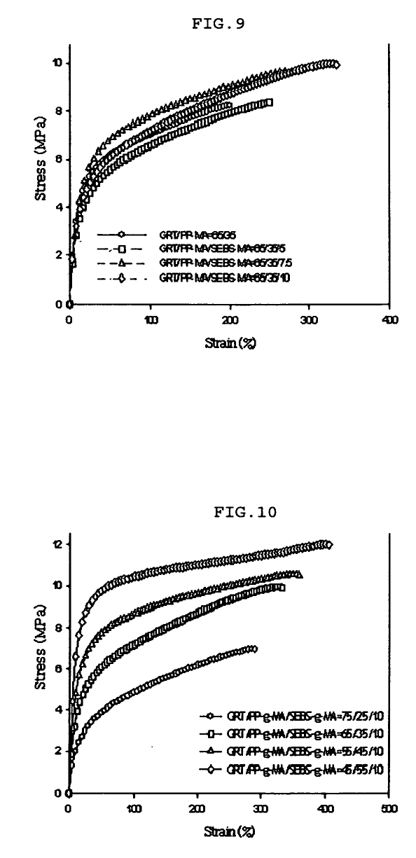

As mentioned above, the mechanical properties were measured while changing the amount of compatibilizer at the rotation speed of the twin-screw extruder of 100 rpm. The results are shown in FIG. 9. As shown in FIG. 9, the mixture loaded into the twin-screw extruder was prepared by changing the amount of compatibilizer into 0, 5, 7.5 and 10 by a weight ratio while setting the waste tire powder (GRT) and PP-g-MA to a weight ratio of 65:35, and the properties thereof were compared.

As is apparent from FIG. 9, since the waste rubber powder is very fine, the surface area thereof is considerably large. Therefore, as the amount of compatibilizer increases, the compatibility between the waste rubber and PP can be seen to gradually rise. From this result, it has been confirmed that the greatest mechanical properties are assured when the amount of compatibilizer is 10 phr. In addition, the mechanical properties varying with the mixing ratio of waste tire and PP upon the use of compatibilizer of 10 phr were evaluated as follows.

[Evaluation of Mechanical Properties Depending on Mixing Ratio of Waste Tire and PP]

The mechanical properties depending on the change in amounts of waste tire and PP were evaluated when the rotation speed of the twin-screw extruder was 100 rpm and the amount of compatibilizer was 10 phr. The results are shown in FIG. 10. In the composition of the mixture loaded into the twin-screw extruder, the amount of compatibilizer (SEBS-MA) was set to 10 by a weight ratio and the amounts of waste tire powder (GRT) and PP-g-MA were changed, as shown in FIG. 9.

In the present test, when the waste rubber is used in a large amount of 75 by a weight ratio, rubber properties are good but the mechanical properties are decreased as in FIG. 10. Moreover, it is difficult to process the mixture. Further, when the waste rubber is used in a small amount of 45 or 55 by a weight ratio, even though the mechanical properties are good, the mixture has plastic properties greater than rubber properties to be unsuitable for use in rubber material.

On the other hand, the waste rubber was subjected to UV treatment under various conditions. Specifically, the modified waste rubber powder through UV treatment and the non-modified waste rubber powder were added in amounts varying from 10 to 70 by a weight ratio to the PP and compatibilizer supplied at a suitable ratio, and the mechanical properties were measured. From this result, it can be seen that the use of the modified powder leads to superior properties. As such, the greatest grafting ratio can be obtained upon UV treatment for 30 min using 1.25 mol allylamine.

As described hereinbefore, the present invention provides a thermoplastic elastomer using waste rubber and a rubber product produced therefrom. In the present invention, since waste rubber can be converted into a thermoplastic rubber material to recycle it, it is possible to perform a recycling process several times, instead of a conventional recycling process responsible for only a filling function. Particularly, products produced from the thermoplastic elastomer of the present invention can be recycled several times through a melting process. Further, such products are obtained through a continuous process in a twin-screw extruder, therefore increasing productivity and achieving a simple process.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A thermoplastic elastomer using waste rubber, obtained by loading a mixture comprising waste rubber powder, an olefin-based thermoplastic resin, and a compatibilizer selected from styrene compounds into an extruder and then kneading it.

2. The elastomer as set forth in claim 1, wherein the extruder is a twin-screw extruder in which two shafts, each having at least two forward screw parts, at least one kneading disc part, and at least one backward screw part, are arranged in parallel to each other.

3. The elastomer as set forth in claim 1, wherein the waste rubber powder has an amine group introduced thereto.

4. The elastomer as set forth in claim 1, wherein the mixture comprises 65˜70 parts by weight of the waste rubber powder, 35˜25 parts by weight of the olefin-based thermoplastic resin, and 5˜10 parts by weight of the compatibilizer.

5. The elastomer as set forth in claim 1, wherein the waste rubber powder is automobile waste tire powder or automobile weather stripping powder.

6. The elastomer as set forth in claim 1, wherein the olefin-based thermoplastic resin is at least one selected from polypropylenes (PP), polyethylenes (PE), and polyurethanes (PU).

7. The elastomer as set forth in claim 1, wherein the olefin-based thermoplastic resin is maleic anhydride grafted polypropylene (PP-g-MA).

8. The elastomer as set forth in claim 1, wherein the compatibilizer is at least one selected from styrene-ethylene-butadiene-styrene (SEBS) and maleic anhydride grafted styrene-ethylene-butadiene-styrene (SEBS-MA).

9. The elastomer as set forth in claim 2, wherein the twin-screw extruder is operated at a rotation speed of 80˜150 rpm and at a temperature of 190˜240° C.

10. The elastomer as set forth in claim 3, wherein the waste rubber powder has the amine group introduced thereto by mixing it with a solution including allylamine and benzophenone to prepare a mixture, which is then dried and irradiated with UV for 20-50 min.

11. A rubber product, produced using the thermoplastic elastomer of any one of claims 1 to 10.

12. The product as set forth in claim 11, which is a wheel of a garbage can.
